(19) United States
(12) Patent Application Publication
(10) Pub. No.: US 2025/0067763 A1
(43) Pub. Date: Feb. 27, 2025

(54) SAMPLER AND ANALYZER WITH SAMPLER

(71) Applicant: Analytik Jena GmbH+Co. KG, Jena (DE)

(72) Inventors: Marcel Freundel, Ilmenau (DE); Henri-Alan Traute, Ilmenau (DE); Heiko Henneberg, Plaue (DE)

(21) Appl. No.: 18/813,300

(22) Filed: Aug. 23, 2024

(30) Foreign Application Priority Data
Aug. 23, 2023 (DE) 10 2023 122 582.0

(51) Int. Cl. G01N 35/04

(52) U.S. Cl. CPC G01N 35/04; G01N 2035/0405; G01N 2035/0441; G01N 2035/0475

(57) ABSTRACT

A sample feeder for dispensing samples includes a base apparatus, an dispensing device, and an activation apparatus. A carrier apparatus includes a carrier plate, a plurality of sample receptacles in the form of traversing passageways, and a platelike closure apparatus. The activation apparatus includes a rotational movement apparatus and a linear movement apparatus. The rotational movement apparatus rotates the carrier plate about an axis, relative to which the closure apparatus is embodied movably. The closure apparatus in a first position relative to the axis closes an end of each sample receptacle and in a second position relative to the axis opens the end of exactly one sample receptacle. The linear movement apparatus moves the closure apparatus between the first and the second position. An analyzer includes a sample feeder according to the present disclosure.

### CROSS-REFERENCE TO RELATED APPLICATION

The present application is related to and claims the priority benefit of German Patent Application No. 10 2023 122 582.0, filed Aug. 23, 2023, the entire contents of which are incorporated herein by reference.

### TECHNICAL FIELD

The present disclosure relates to a sampler, in particular a sample feeder. Additionally, the present disclosure relates to an analyzer having at least one such sample feeder.

### BACKGROUND

In the field of analysis, sample feeders enable an automated handling of a large number of samples, which are fed sequentially by the sample feeder to an analyzer.

DE 20 2019 102 011 U1 describes a sample feeder having a magazine disk, which has openings for individual samples. A disk below the magazine disk prevents that the samples slip out of the openings because of the force of gravity. The disk has an opening, via which a sample can be selected. Details of how this is done are not disclosed. Shown in DE 28 18 614 A1 is a sample feeder, in the case of which a trapdoor below a star wheel enables selection of a sample. The structure in US 2011/0239792 A1 is similar. Described in DE 36 89 521 T2 is a sample feeder having a carousel for individual samples. The angular position of the carousel is registered by a Hall sensor. The sample feeder according to DE 31 02 774 A1 includes a probe, which withdraws liquids from a rotatable sample supply. A rotating sample rack is disclosed likewise in EP 3 578 968 B1. In such case, sample containers are held by a blocking apparatus in housing seats. A sensor monitors in each case whether a container is located in a seat.

A problem with sample feeders is, most often, that they have frequently a very complex and, consequently, in principle, a rather malfunction susceptible construction.

### SUMMARY

An object of the present disclosure is to provide a simply embodied feeding of samples with the opportunity for choosing any of the samples as the next-fed sample. The object is achieved by providing a sample feeder and an analyzer including the sample feeder according to the present disclosure.

A sample feeder according to the present disclosure comprises at least one base apparatus and one carrier apparatus, wherein the base apparatus includes an dispensing device and an activation apparatus, wherein the carrier apparatus includes a plurality of sample receptacles for receiving samples and a closure apparatus, wherein the activation apparatus is embodied in such a manner that it controls the carrier apparatus and the closure apparatus in such a manner that a sample gets from a selected sample receptacle to the dispensing device, wherein the activation apparatus includes a rotational movement apparatus and a linear movement apparatus, wherein the carrier apparatus includes a carrier plate and the closure apparatus, wherein the sample receptacles are traversing passageways, wherein the rotational movement apparatus rotates the carrier plate about an axis, wherein the closure apparatus is embodied plate like, wherein the closure apparatus is embodied movably, preferably linearly movably, relative to the axis, wherein the closure apparatus in a first position relative to the axis closes an end of each sample receptacle, wherein the closure apparatus in a second position relative to the axis opens the end of exactly one sample receptacle, and wherein the linear movement apparatus moves the closure apparatus from the first to the second and/or from the second to the first position.

The activation apparatus effects that each sample falls from the carrier apparatus out of its sample receptacle by the force of gravity. Thus, the activation apparatus can also be referred to as a sample discharge apparatus.

The sample feeder of the present disclosure has a base apparatus and a carrier apparatus. Preferably, the base apparatus and the carrier apparatus are separable from one another. Therefore, the carrier apparatus can be populated with samples e.g., at another location, this being a great advantage. The carrier apparatus is, in such case, preferably closed below when populating, in order to keep samples from falling out. Then, the carrier apparatus with the samples is connected with the base apparatus, preferably plugged on or set on.

The base apparatus includes an dispensing device and an activation apparatus. The dispensing device serves for connecting e.g., with an analyzer. This is, thus, a sort of interface for transfer of the samples. The activation apparatus effects that, in each case, a selected sample gets from the carrier apparatus to the dispensing device. The carrier apparatus has a plurality of—thus, for example, more than two, or, for example, 40—sample receptacles, into which samples are placed, as well as a closure apparatus. The closure apparatus closes—at least partially, and/or at least preferably in a (removal-) direction—the sample receptacles, such that the samples in the sample receptacles are kept from the slipping out as a result of the acting gravitational pull.

The activation apparatus is embodied such that it acts on the carrier apparatus and the closure apparatus. This acting is, e.g., such that the activation apparatus moves the carrier apparatus and/or the closure apparatus. The result of this acting on the carrier apparatus and the closure apparatus is that a sample from a selected sample receptacle gets to the dispensing device.

A significant advantage of the sample feeder of the present disclosure is that, with few components, it is possible to select individual samples, wherein the easily provided force of gravity is utilized.

The activation apparatus operates a rotational movement apparatus, which includes, for example, a stepper motor, and a linear movement apparatus, in order to move a sample from a selected sample receptacle to the dispensing device.

Thus, with the rotational movement apparatus, a carrier plate, which belongs to the carrier apparatus, is rotated about an axis. This preferably effects the positioning of the selected sample receptacle relative to the dispensing device.

In an embodiment, the carrier plate is rotated in such a manner that the selected sample receptacle is located-preferably aligned-above the dispensing device.

The linear movement apparatus moves the closure apparatus from one position to another position. In this way, it is effected that the closure of the selected sample receptacle and, preferably, only the one selected sample receptacle is opened and the sample can leave the selected sample receptacle. The slipping out presumes that the force of gravity can act appropriately on the sample, thus that the sample feeder is suitably oriented. Between the two positions of the closure apparatus, there occurs a linear movement relative to the axis, about which the carrier apparatus is rotated.

The closure apparatus has a plate-like basic form. The two positions of the closure apparatus differ in that either all of the sample receptacles are closed (first position) on one end, the lower end, or one—thus, the selected-sample receptacle is open (second position) on that end. The mentioned and, depending on position of the closure apparatus, closed end is preferably a—in the direction of the gravitational pull—lower end of the sample receptacles, such that, in the case of opened end, the selected sample can freely escape under the influence of the gravitational pull. If, thus, the closure apparatus moves from the first into the second position, then this means that an end of a sample receptacle is opened. If, conversely, the movement from the second into the first position occurs, then said end of the selected sample receptacle is reclosed. The linear movement apparatus executes, in such case, depending on embodiment, the movement from the first to the second or from the second to the first position. Alternatively, the movement between the two positions is effected both back as well as forth.

In an embodiment, the sample receptacles are distributed on a circle and, preferably, arranged with the same angular displacement relative to one another. There is in this embodiment, thus, a uniform distribution of the sample receptacles about a shared center. The sample number is, in such case, limited by the diameter of the part of the carrier apparatus, which serves to accommodate the sample receptacles, and also by the dimensioning of the sample receptacles. An advantage of the arrangement in a circle is that also embodiments with few sample receptacles can be implemented and variable sample metering is easily and reliably possible.

In a supplemental embodiment, the sample receptacles are located on a plurality of circles of different radii.

An embodiment of the sample feeder provides that the base apparatus further includes a housing, and the dispensing device is embodied as an opening in the housing. In this embodiment, the dispensing device is e.g., a hole in the housing of the base apparatus, through which, in each case, a sample, for example, under the action of the force of gravity, arrives at (concretely, falls into) the analyzer.

An embodiment of the sample feeder provides that the closure apparatus has an essentially closed area, that an opening is located centrally in the closed area, and that an edge cutout is located on an outer edge of the closed area. The platelike closure apparatus has in this embodiment a closed area, which at least allows closure of the sample receptacles on one end—preferably on the lower end. The closed area is interrupted by at least two openings: a central opening and an edge cutout. The central opening is located preferably centrally in the closed area and enables a, for example, linear, alternating of the position of the closure apparatus relative to the carrier apparatus. About the central opening is located the preferably broadly embodied band of the closed area. On the outer edge of the closure apparatus there is an edge cutout, which is formed, for example, such that an elongated fjord extends in the radial direction. If, then, the positions of closure apparatus and carrier apparatus are changed relative to one another, then there also changes the position between a sample receptacle and the edge cutout, such that, for example, the selected sample receptacle is no longer closed by the closure apparatus and the sample located therein can, e.g., slip out. The—preferably lower—end of the selected sample receptacle and the edge cutout align, e.g., with one another, this being controlled by the rotation of the carrier apparatus.

In an embodiment, the sample feeder includes, furthermore, a spring element, wherein the spring element exerts a force on the closure apparatus, which acts from the second in the direction of the first or from the first in the direction of the second position. In this embodiment, on the one hand, the linear movement apparatus and, on the other hand, the spring element act on the closure apparatus. Preferably, the linear movement apparatus and the spring element act in different directions.

An embodiment of the sample feeder provides that the carrier apparatus includes an axis device, that the base apparatus includes a carrier receiving apparatus for receiving the axis device and a detection apparatus, and that the detection apparatus is embodied in such a manner that it detects whether the carrier apparatus with the axis device is set on the carrier receiving apparatus. In this embodiment, the base apparatus has a carrier receiving apparatus, which preferably defines the axis, about which the carrier apparatus rotates. The carrier receiving apparatus is, for example, a rotatable shaft. An axis device of the carrier apparatus is set on the carrier receiving apparatus, such that preferably the carrier apparatus can be rotated about the axis. In such case, a detection apparatus is present, which detects, whether the carrier apparatus has been mounted. Thus, for example, the sample feeder is only activated, when the detection apparatus produces a corresponding signal that the carrier apparatus is present.

An embodiment of the sample feeder provides that the detection apparatus includes a Hall sensor, and the carrier receiving apparatus has a magnet component. In this embodiment, e.g., the mounting of the carrier apparatus acts in such a manner on the preferably axially movable magnet component that the Hall sensor detects the mounting. Thus, for example, the force, which the carrier apparatus exerts on the carrier receiving apparatus during the mounting, moves the magnet component in the direction of the Hall sensor. An advantage of a Hall sensor is that its sensitivity is, as a rule, large enough, such that, e.g., a stainless steel shaft, about which the carrier apparatus is rotated, scarcely disturbs a measurement.

In an alternative embodiment, the detection apparatus includes a reed-contact.

An embodiment of the sample feeder provides that the linear movement apparatus and the closure apparatus are releasably connected with one another via a force transfer apparatus when the carrier apparatus is mounted on the base apparatus. The positioning of the carrier apparatus on the base apparatus effects in this embodiment that a releasable contacting by a force transfer apparatus is produced between the linear movement apparatus and the closure apparatus. Such a releasable connection is preferably necessary, because the linear movement apparatus and the closure apparatus are associated with the mutually releasable building blocks: basic apparatus and carrier apparatus, which are preferably only connected together when in use.

An embodiment of the sample feeder provides that the force transfer apparatus has a pin unit and a hole unit. In this embodiment, the force transfer is produced by the pin unit engaging in the hole unit. Thus, this type of coupling in a variant takes into consideration especially that the carrier apparatus is set on the base apparatus.

An embodiment of the sample feeder provides that the axis device and/or the carrier receiving apparatus include(s) an orientation device, and the orientation device enables a setting of the carrier apparatus on the carrier receiving apparatus in only one orientation. In this embodiment, it is assured that a predetermined orientation exists between axis device and carrier receiving apparatus. Such is especially advantageous when the sample receptacles are encoded, in order to simplify the selection of the individual sample receptacles. Thus, the orientation device assures, for example, that a sample receptacle with the number “one” has a predetermined solid angle relative to the base apparatus.

In an embodiment, the orientation device has an extending structure (e.g., in the manner of a lug), which engages in a cavity of the carrier apparatus.

An embodiment of the sample feeder provides that the linear movement apparatus has a motor—preferably in the form of a rotary motor or a stepper motor—and an eccentric. The eccentric in an embodiment changes the rotating movement of the rotary motor into a linear movement. In an embodiment, the rotary motor belongs to the rotational movement apparatus and the eccentric is only activated when shifting the closure apparatus. The rotary motor is, for example, a DC-motor. In an alternative embodiment, a stepper motor is connected directly with the eccentric.

An embodiment of the sample feeder provides that the rotational movement apparatus includes a rotation angle sensor-preferably in the form of a rotary encoder. The rotation angle sensor serves in this embodiment for assuring that the selected sample receptacle is at the right position-preferably aligned above the dispensing device.

Furthermore, the present disclosure relates to an analyzer having at least one sample feeder according to one of the preceding or following embodiments. In order to avoid repetition, the above and subsequently discussed embodiments of the sample feeder hold also for the analyzer and vice versa.

### BRIEF DESCRIPTION OF THE DRAWINGS

The present disclosure will now be explained in greater detail based on the appended drawings, the figures of which are as follows:

FIG. 1 shows a perspective view of an embodiment of a sample feeder according to the present disclosure;

FIG. 2 shows a perspective view of the base apparatus of the sample feeder of FIG. 1;

FIG. 3 shows a schematic view of a first embodiment of the activation apparatus;

FIG. 4 shows a schematic view of the region surrounding the carrier receiving apparatus of the base apparatus;

FIG. 5a shows a schematic plan view of cooperation between the carrier plate and closure apparatus, greatly simplified for clarity;

FIG. 5b shows a side section view through the schematic of FIG. 5a along line A-A;

FIG. 6 shows a perspective view of an analyzer with the sample feeder of FIG. 1;

FIG. 7a shows a schematic side view a second embodiment of the activation apparatus according to the present disclosure; and

FIG. 7b shows a schematic plan view of the second embodiment of the activation apparatus shown in FIG. 7a.

### DETAILED DESCRIPTION

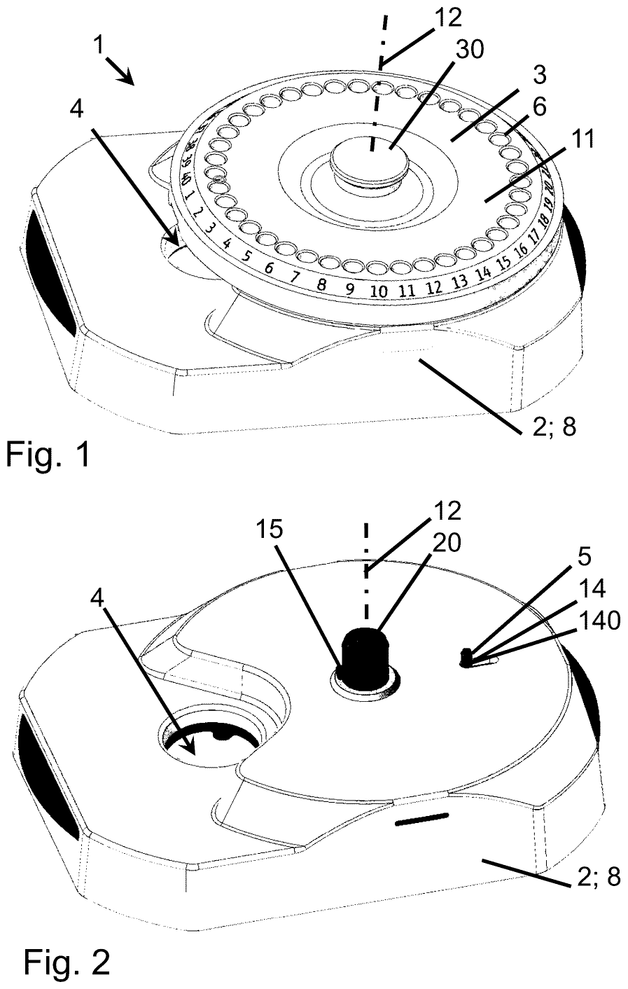

FIG. 1 shows how a sample feeder 1 according to the present disclosure is composed of a base apparatus 2 and a carrier apparatus 3.

The plate-shaped carrier plate 11 of the carrier apparatus 3 contains a plurality of sample receptacles 6, which are distributed and numbered around an outside region of the carrier plate 11. In use, the carrier apparatus 3 rotates about the axis 12, which extends through the knob like axis device 30 centrally of the carrier apparatus 3. The housing 8 of the base apparatus 2 has an opening, which serves as an dispensing device 4 for the samples in the carrier plate 11. FIG. 2 shows the base apparatus 2 without the carrier apparatus 3.

The top of the housing 8 includes a planar area. Visible in FIG. 2 is the orientation device 15 adjoining the columnar carrier receiving apparatus 20 and on both of which the carrier apparatus 3 is placed. When in place, a certain spacing from the top of the housing 8 remains. Located on a side (the left side in FIG. 2) is a cutback region of the top of the housing 8, where the dispensing device 4 is located in the form of a hole in the housing 8.

Located centrally in the top of the housing 8 is the circularly cylindrical carrier receiving apparatus 20, on which the axis device 30 of the carrier apparatus 3 rests when in use. Extending through the carrier receiving apparatus 20 is also the axis 12, about which the rotation of the carrier apparatus 3 occurs. Aligned behind the dispensing device 4 on the carrier receiving apparatus 20 is the lug-shaped orientation device 15, which assures that the carrier apparatus 3 is mounted with a starting orientation.

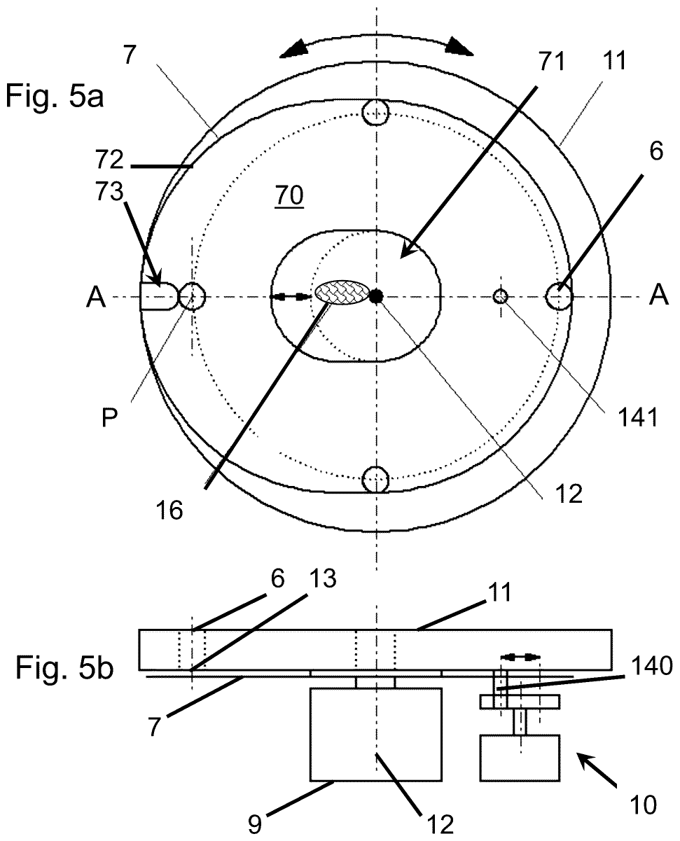

In such case, likewise, located aligned with the dispensing device 4 is the force transfer apparatus 14, which uses a pin unit 140. In application, pin unit 140 engages in a hole unit 141 (shown in FIG. 5a). Force transfer apparatus 14 is part of, in such case, the activation apparatus 5 and effects, above all, the slipping out of the sample from the selected sample receptacle.

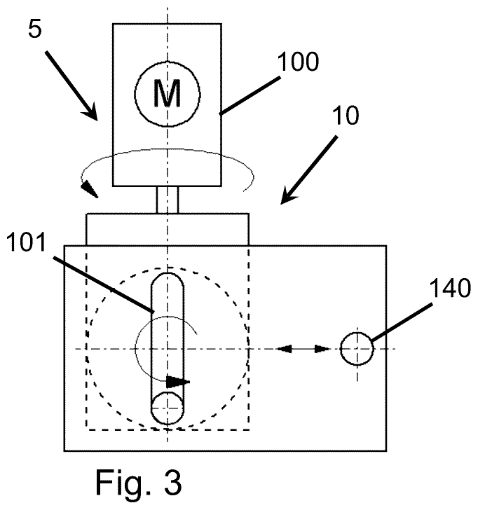

FIG. 3 shows schematically the structure of the linear movement apparatus 10 as part of the activation apparatus 5. In such case, the pin unit 140 is linearly shifted by the interaction of the rotational movement of the motor 100 (embodied here as a rotary motor) with the eccentric 101. The pin unit 140, in turn, shifts the closure apparatus 7 (compare FIG. 5).

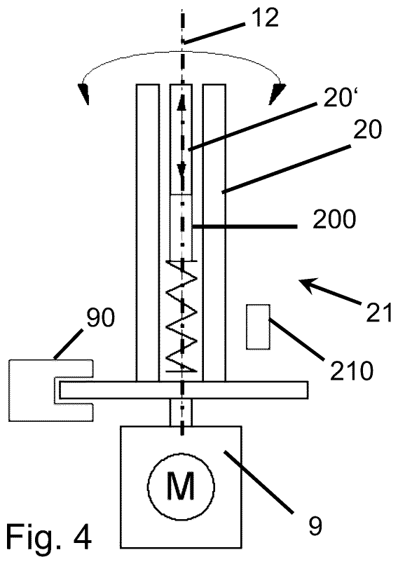

FIG. 4 shows the principle of detecting whether the carrier apparatus 3 is on the base apparatus 2.

The axis device 30 rests on the shaft-formed carrier receiving apparatus 20 and on the orientation device 15. In such case, it surrounds its upper end (compare FIG. 1). In this way, it presses the upper push rod 20′ and below such the movable magnet component 200 against the spring downwards along the axis 12, about which the carrier plate 11 rotates (indicated by the curved double arrow). This causes the Hall sensor 210, as other component of the detection apparatus 21, to produce a signal, indicating that the sample feeder is occupied and ready for use. The signal is, in such case, received by a control unit (not shown), which also controls the sample feeder or here, e.g., also the rotational movement apparatus 9. For the controlling rotation of the carrier apparatus 3, such that the selected sample receptacle 6 is arranged preferably aligned above the dispensing device 4, a rotary encoder is present in the example as rotation angle sensor 90.

In use, then, the carrier apparatus 3 with the samples in the sample receptacles 6, which are closed on the lower end by the closure apparatus 7, is set on the base apparatus 2. The result of this placement is detected and desired sample receptacles 6 are rotated to the discharge position above the dispensing device 4. Then, the closure apparatus 7 is moved linearly such that exactly the one desired sample receptacle 6 can issue its sample.

The schematic plan view and section of FIGS. 5 a) and b), respectively, will now be used together to explain the selection and release of a sample.

In the illustrated example, only four sample receptacles 6 are present as traversing bores on and in the carrier plate 11. The sample S, which is be examined next in the analyzer, is located on the left side. The curved double arrow shows that the carrier plate 11 can be rotated by the rotational movement apparatus 9 in both directions about the axis 12.

Located beneath the carrier plate 11 is the closure apparatus 7, which is a component of the carrier apparatus 3. Closure apparatus 7 has a largely closed area 70, which extends at least over a circular band, such that the sample receptacles 6 in the here illustrated, first position relative to the axis 12 are closed on their lower ends 13 and the samples therein are prevented from slipping out.

In the illustrated embodiment, the central opening 71 is oval-shaped. The central opening 71 is embodied with a dimensioning such that a linear movement perpendicularly to the axis 12 that the edge cutout 73 opens exactly one sample receptacle 6—thus, in this case, the left one. Edge cutout 73 is a recess extending inwardly from the outer edge 72. If the edge cutout 73 is aligned below the selected sample receptacle 6, then the sample S can fall downwards.

Located on the closure apparatus 7 diametrally opposite the edge cutout 73 is the hole unit 141, which interacts with the pin unit 140 located thereunder. The carrier apparatus 3 is placed on the base apparatus 2 with the pin unit 140 protruding into the hole unit 141 of the closure apparatus 7, such that the opening of selected sample receptacles 6 can be accomplished.

The linear movement apparatus 10 can, consequently, such as indicated by the straight double arrow, move the closure apparatus 7 into the second position. The returning from the second in the first position is effected in the illustrated embodiment by a spring element 16.

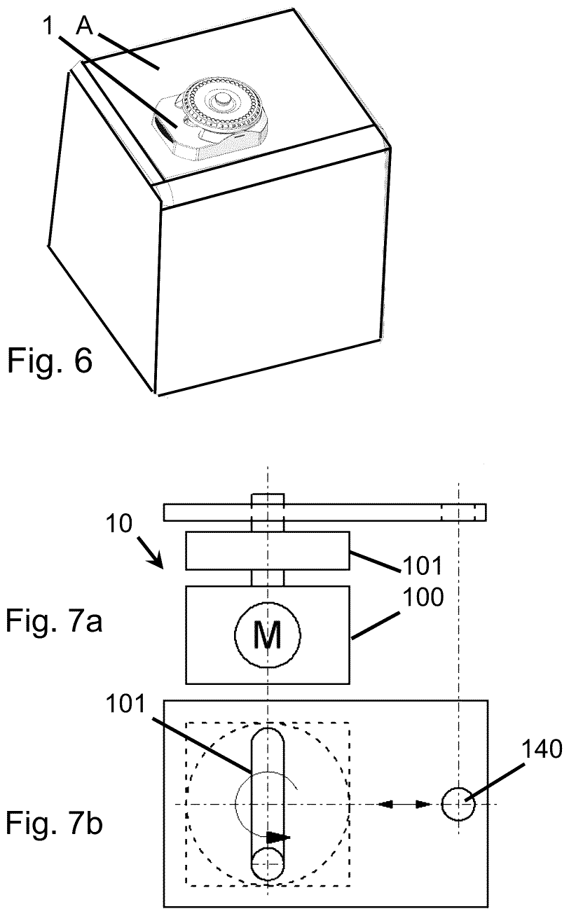

FIG. 6 shows an analyzer A, on which the sample feeder 1 is mounted. In such case, an oven, for example, is located below the dispensing device for burning the sample for further analysis.

FIGS. 7a and 7b show schematically a second implementation of the linear movement apparatus 10 in a sectioned side view, FIG. 7a, and in a plan view, FIG. 7b. The motor 100 of the linear movement apparatus 10 is, in such case, a stepper motor, which is connected directly with an eccentric 101. Eccentric 101 moves (as indicated by the straight double arrow) the plate-like carrier, on which the pin unit 140 is located. The axis around which the eccentric 101 rotates (indicated by the curved arrow) is, in such case, perpendicular to the axis, along which the pin unit 140 is shifted.

1. A sample feeder for dispensing samples, the sample feeder comprising:
a base apparatus and a carrier apparatus,
wherein the base apparatus includes a dispensing device and an activation apparatus,
wherein the carrier apparatus includes a plurality of sample receptacles, each configured to receive samples, and a closure apparatus,
wherein the activation apparatus is configured so as to control the carrier apparatus and the closure apparatus such that a sample from a selected sample receptacle gets to the dispensing device,
wherein the activation apparatus includes a rotational movement apparatus and a linear movement apparatus,
wherein the carrier apparatus includes a carrier plate and the closure apparatus,
wherein the sample receptacles traverse passageways,
wherein the rotational movement apparatus rotates the carrier plate about an axis,
wherein the closure apparatus is configured plate-like,
wherein the closure apparatus is configured to move linearly relative to the axis,
wherein the closure apparatus, in a first position relative to the axis, closes an end of each sample receptacle,
wherein the closure apparatus, in a second position relative to the axis, opens the end of exactly one sample receptacle, and
wherein the linear movement apparatus moves the closure apparatus from the first to the second and/or from the second to the first position.

2. The sample feeder according to claim 1, wherein the base apparatus further includes a housing, and the dispensing device is configured as an aperture in the housing.

3. The sample feeder according to claim 1, wherein the closure apparatus includes an essentially closed area, wherein an opening is located centrally in the closed area, and
wherein an outer edge of the closed area includes an edge cutout.

4. The sample feeder according to claim 1, wherein the sample feeder further includes a spring element, and
wherein the spring element exerts a force on the closure apparatus, which force acts from the second position in the direction of the first position or from the first position in the direction of the second position.

5. The sample feeder according to claim 1, wherein the carrier apparatus includes an axis device,
wherein the base apparatus includes a carrier receiving apparatus configured to receive the axis device and a detection apparatus, and
wherein the detection apparatus is configured so as to detect whether the carrier apparatus with the axis device is set on the carrier receiving apparatus.

6. The sample feeder according to claim 5, wherein the detection apparatus includes a Hall sensor, and
wherein the carrier receiving apparatus includes a magnet component.

7. The sample feeder according to claim 1, wherein the linear movement apparatus and the closure apparatus are releasably connected with each other via a force transfer apparatus when the carrier apparatus is mounted on the base apparatus.

8. The sample feeder according to claim 1, wherein the force transfer apparatus includes a pin unit and a hole unit.

9. The sample feeder according to claim 5, wherein the axis device and/or the carrier receiving apparatus include(s) an orientation device, and wherein the orientation device enables a setting of the carrier apparatus on the carrier receiving apparatus in only one orientation.

10. The sample feeder according to claim 1, wherein the linear movement apparatus includes a motor and an eccentric.

11. The sample feeder according to claim 10, wherein the motor is a rotary motor or a stepper motor.

12. The sample feeder according to claim 1, wherein the rotational movement apparatus includes a rotation angle sensor.

13. The sample feeder according to claim 1, wherein the rotation angle sensor is a rotary encoder.

14. An analyzer comprising at least one sample feeder according to claim 1.
